(19) United States
(12) Patent Application Publication
(10) Pub. No.: US 2012/0273455 A1
(43) Pub. Date: Nov. 1, 2012

(54) METHODS FOR ALIGNED TRANSFER OF THIN MEMBRANES TO SUBSTRATES

(75) Inventors: William Martin Lackowski, Austin, TX (US); William Neil Everett, Cedar Park, TX (US); Joseph F. Pinkerton, Austin, TX (US)

(73) Assignee: CLEAN ENERGY LABS, LLC, Austin, TX (US)

(21) Appl. No.: 13/098,101

(22) Filed: Apr. 29, 2011

(51) Int. Cl. H01B 3/08

(52) U.S. Cl. 216/20

(57) ABSTRACT

The present invention relates to thin membranes (such as graphene windows) and methods of aligned transfer of such thin membranes to substrates. The present invention further relates to devices that include such thin membranes.

The present invention relates to thin membranes (such as graphene) and methods of aligned transfer of such thin membranes to substrates. The present invention further relates to devices that include such thin membranes.

### BACKGROUND

Graphene sheets—one-atom-thick two-dimensional layers of sp2-bonded carbon—have a range of unique electrical, thermal and mechanical properties. Just as glass windows are supported on all sides by a stronger frame structure (such as a wall), a “graphene window” is graphene supported on all sides by a much thicker material (typically metal). Graphene windows can be any shape, such as a round shape like a drum. The graphene of a graphene window generally is grown on its supporting metal (such as Cu).

An advantage of graphene windows is that they can be transferred to another substrate (such as the metal-oxide portion of a graphene-drum switch) without the use of liquid (which tends to tear the graphene when the liquid dries). A reason the graphene windows of the present invention are larger and cleaner than any known to be reported in the literature is because a production method has been developed that among other improvements, uses very pure metal foils as a starting point. In addition to graphene-drum switches, graphene windows can be used to make graphene pumps and other NEM devices. As the terms “thin membrane window,” “graphene windows,” and the like are used herein, once these have been transferred to another substrate, they are still referred to as “thin membrane window,” “graphene windows,” etc.

In addition to graphene windows that are larger and cleaner, it has been found that coating at least one side of the graphene with a few nanometer thick layer of metal can lower the membrane's electrical resistance by an order of magnitude, which is advantageous when making electrical devices out of graphene (such as graphene-based low-loss switches).

Graphene windows, method for making same, and devices containing same are described in co-pending U.S. Patent Appl. No. 61/427,011 to Everett et al. (“the '011 Patent Application”), which is incorporated herein in its entirety.

### SUMMARY OF THE INVENTION

The present invention relates to thin membranes (such as graphene windows) and methods of aligned transfer of such thin membranes to substrates. The present invention further relates to devices that include such thin membranes.

The present invention relates to an efficient, facile method for transferring thin membranes to substrates following alignment of the membranes to substrate features. In embodiments of the present invention, this method has been used to transfer arrays of single-layer graphene windows onto silicon target test chips. The transfer method of the present invention has advantages over other transfer methods in that it eliminates steps that chemically or physically modify the thin membrane when transferred onto the target substrate, such as the need to immerse one or both sides of the transferred thin membrane in a liquid. The present invention also provides for the ability to control the composition of the ambient environment during the thin membrane transfer. Such environmental control is useful for systems where, for example, effective transfer yield, particulate contamination, oxidative corrosion processes, and/or gaseous dielectric strength need to be controlled.

In general, in one aspect, the invention features a method that includes back etching a first thin membrane substrate to form a first thin membrane window array. The first thin membrane substrate has a first side and a second side. The first thin membrane window array is formed on the second side of the first thin membrane substrate. The method further includes adhering a first side of a flexible substrate to the first side of the first thin membrane substrate. The method further includes aligning the first thin membrane window array to a first side of a target substrate. The first side of the target substrate includes a first target feature array to which the first thin membrane window array is aligned. The method further includes contacting the first thin membrane window array to the first side of the target substrate while maintaining alignment. The method further includes transferring the first thin membrane window array to the first target feature array on the first side of the target substrate.

Implementations of the inventions can include one or more of the following features:

The method can further include adhering a first side of a rigid substrate to a second side of the flexible substrate.

The rigid substrate can be transparent.

The rigid substrate can include glass.

The flexible substrate can be transparent.

The flexible substrate can be an elastomer.

The elastomer can include cross-linked polydimethylsiloxane.

The method can further include removing the flexible substrate and the first thin membrane substrate while maintaining the first thin membrane window array on the first target feature array of the target substrate.

The first thin membrane substrate can be a metal.

The mean surface roughness can be less than 0.5 microns.

The metal can be copper.

The first thin membrane window array can include graphene.

The first thin membrane window array can include graphene oxide.

The first thin membrane window array can include a graphene/thin metal film composite.

The first thin membrane window array can have no more than one thin membrane window.

The first thin membrane window array can include more than one thin membrane windows.

The first thin membrane substrate can include a first set of alignment marks. The target substrate can include a second set of alignment marks. The step of aligning the first thin membrane window array to a first side of a target substrate can include aligning the first set of alignment marks with the second set of alignment marks.

The method can further include transferring a second thin membrane window array to the first side of the target substrate.

The step of transferring the second thin membrane window array to the first side of the target substrate can include aligning the second thin membrane window array to the first side of a target substrate. The second thin membrane window array can be located on a second side of the second thin membrane window substrate. The first side of the target substrate can include a second target feature array to which the second thin membrane window array is aligned. The step of transferring the second thin membrane window array to the first side of the target substrate can include contacting the second side of the second thin membrane window array against the first side of the target substrate while maintaining alignment. The step of transferring the second thin membrane window array to the first side of the target substrate can include transferring the thin membranes of the second thin membrane window array to the second target feature array on the first side of the target substrate.

The second thin membrane window array can be aligned with the first thin membrane window array.

The second thin membrane window array can be aligned with the first thin membrane window array to create an array of transferred two-layer membrane features.

The second thin membrane window array can be offset from the first thin membrane window array.

The method can further include utilizing a gas pressure differential to assist in the transfer of the thin membranes to the first target feature array.

The can further include utilizing a vapor contained within a gas during transfer. The gas can be air. The ratio of partial pressure of the vapor to the saturation pressure can be in excess of 0.2. The vapor can include water in an amount that is at least about 20% relative humidity.

The method can further include aligning a first side of the second target substrate to the first thin membrane window array on the first side of the target substrate. The first side of the second target substrate can have a second target feature array on the first side of the second target substrate. The method can further include contacting the first thin membrane window array to the first side of the second target substrate while maintaining alignment such that the first thin membrane window array is sandwiched between the target substrate and the second target substrate.

The first target substrate can include an array of electromechanical switches.

The first target substrate can include an array of electromechanical sensors.

The second target substrate can include an array of electromechanical switches.

The second target substrate can include an array of electromechanical sensors.

The graphene windows transferred to the target substrate can be used in a graphene pump.

The graphene windows transferred to the target substrate can be used in a NEMS device.

### DESCRIPTION OF DRAWINGS

FIGS. 1A-1E illustrate an embodiment of the present invention in which a thin membrane window array is transferred to a substrate utilizing a liquid-less transfer method.

FIGS. 2A-2E illustrate an alternate embodiment of the present invention in which a thin membrane window array is transferred to a substrate utilizing a liquid-less transfer method.

FIG. 3 is a SEM image of single-layer graphene windows that have been transferred to a substrate utilizing a liquid-less transfer method.

FIGS. 4A-4E illustrate an embodiment of the present invention in which a thin membrane window array is transferred to a substrate utilizing an alignment method.

FIGS. 5A-5G illustrate an embodiment of the present invention in which multiple thin membrane window arrays are transferred to a substrate utilizing an alignment method to increase transfer density.

FIGS. 6A-6D illustrate an embodiment of the present invention in which a thin membrane window array is transferred to apposing substrate/chips utilizing an alignment method.

### DETAILED DESCRIPTION

The present invention relates to thin membranes (such as graphene windows) and methods of aligned transfer of such thin membranes to substrates. The present invention further relates to devices that include such arrays.

The '011 Patent Application describes methods to produce graphene and methods for making graphene windows and devices containing such graphene windows. In the methods described herein, the free standing thin membranes utilized are free standing graphene windows prepared following the methods described in the '011 Patent Application. While graphene windows are discussed and described herein, the thin membranes utilized in the present invention are not limited to only graphene windows. Rather, the thin membrane can be made of any thin material that is sufficiently mechanically robust (such as, for example, a thin membrane of graphene oxide or any combination of materials that form a sufficiently robust composite material, such as a thin membrane of graphene and graphene oxide) to span the lateral dimensions of the target substrate feature. Thus, the discussion of graphene windows is for exemplary purposes and is not intended to limit the scope of the present invention.

Furthermore, the thin membrane is generally a membrane that is atomically thin. For single-layer graphene membranes, the thickness is sub-nanometer; membranes containing multiple graphene layers, graphene/graphene oxide composites, and graphene/metal films are typically on the order of about 1 to about 25 nanometers.

### Liquid-Less Transfer Method

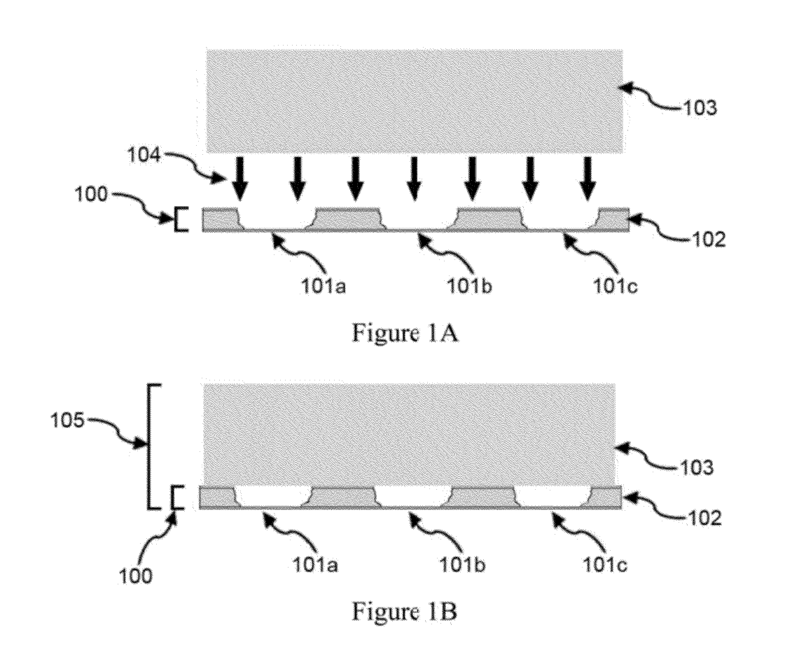

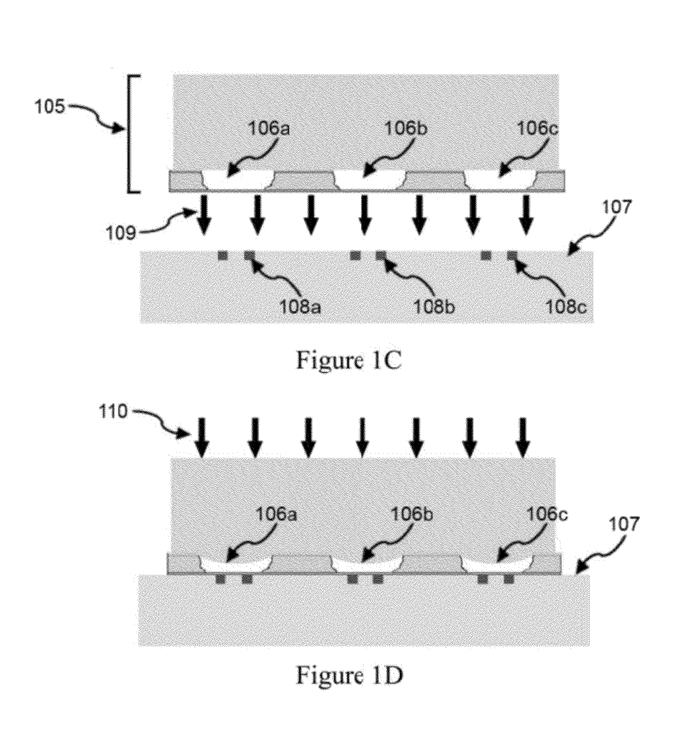

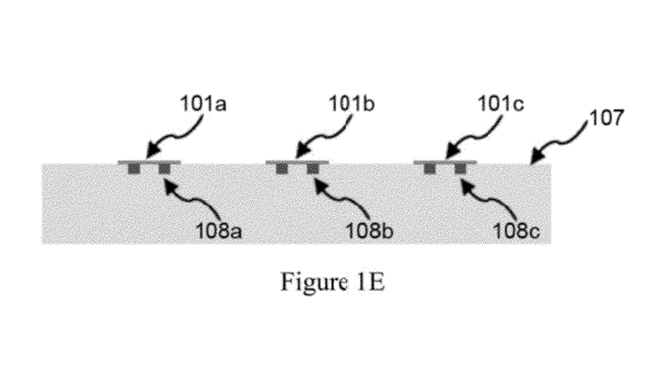

FIGS. 1A-1E illustrate an embodiment of the present invention in which a thin membrane window array is transferred to a target substrate utilizing a liquid-less transfer method.

FIG. 1A depicts an array 100 of thin membranes (graphene windows 101a, 101b, and 101c) on copper foil 102. As shown by arrows 104, array 100 is brought in contact with an elastomeric substrate 103. As shown in FIG. 1A, elastomeric substrate 103 does not have individually addressable ports. In embodiments of the present invention, the elastomeric substrate 103 can be made of polydimethylsiloxane (PDMS).

FIG. 1B depicts the array 100 bound to the elastomeric substrate 103 to form the graphene window/elastomeric substrate 105. Such binding is by weak secondary bonds that are readily reversible.

FIG. 1C depicts the individual sealed chambers (sealed chambers 106a, 106b, and 106c) that were formed on the graphene window/elastomeric substrate 105. As shown by arrows 109, the graphene window/elastomeric substrate 105 is paired with a second substrate 107 (such as a chip). Second substrate 107 has target features (target features 108a, 108b, and 108c). During the pairing of the graphene window/elastomeric substrate 105 with the second substrate 107, the individual sealed chambers (sealed chambers 106a, 106b, and 106c) are aligned with the target features (target features 108a, 108b, and 108c, respectively) and then brought in contact with one another.

FIG. 1D depicts the graphene windows/elastomeric substrate 105 being pressed onto the second substrate 107 (as illustrated by arrows 110). Such pressing causes the graphene windows (graphene windows 101a, 101b, and 101c) in the array 100 to be pressed upon the target features (target features 108a, 108b, and 108c, respectively). As also shown in FIG. 1D, this application of pressure decreases the volume of the sealed chambers (sealed chambers 106a, 106b, and 106c), which increases the pressure inside the sealed pressure (thus causing further compression of the graphene windows upon the target features of second substrate 107).

FIG. 1E depicts the second substrate 107 after the graphene windows/elastomeric substrate 105 is removed, leaving behind the graphene windows (graphene windows 101a, 101b, and 101c) formerly in the array 100. In such a process, the graphene windows (graphene windows 101a, 101b, and 101c) are transferred to the second substrate 107 such that they are aligned with the target features (target features 108a, 108b, and 108c, respectively).

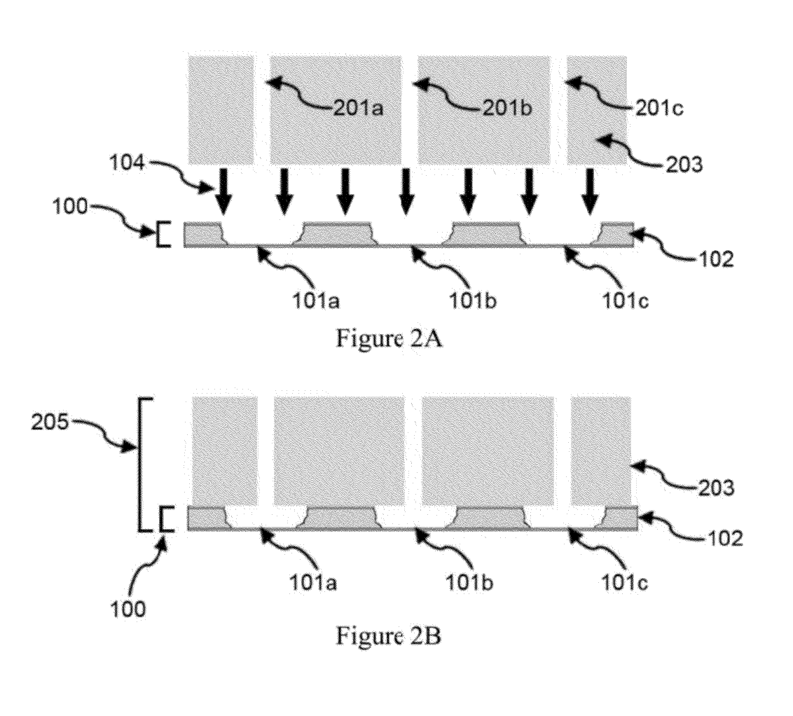

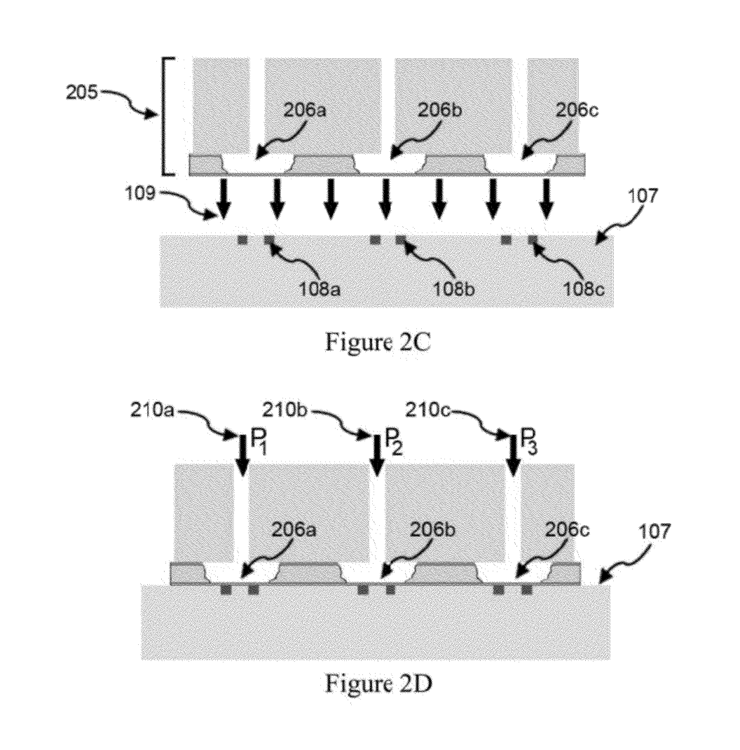

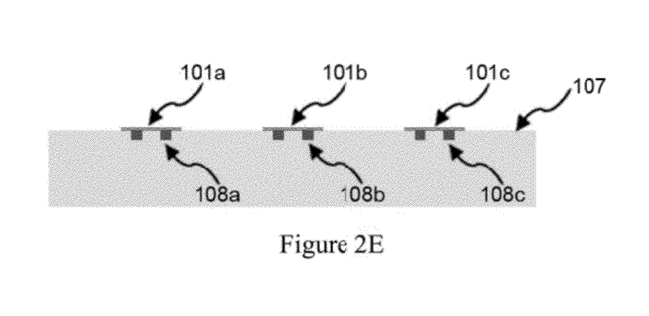

FIGS. 2A-2E illustrate an alternate embodiment of the present invention in which a thin membrane window array is transferred to a substrate utilizing a liquid-less transfer method.

FIG. 2A depicts the array 100 of thin membranes (graphene windows 101a, 101b, and 101c) on copper foil 102. As shown by arrows 104, array 100 is brought into contact with an elastomeric substrate 203. As shown in FIG. 2A (and unlike FIG. 1A), the elastomeric substrate 203 does have individually addressable ports (ports 201a, 201b, and 201c).

FIG. 2B depicts the array of graphene windows 100 bound to the elastomeric substrate 203 to form the graphene window/elastomeric substrate 205. As before, such binding is by weak, reversible secondary bonds.

FIG. 2C depicts individually addressable chambers (addressable chambers 206a, 206b, and 206c) that were formed on the graphene window/elastomeric substrate 205. However, unlike the sealed chambers shown in FIG. 1C (sealed chambers 106a, 106b, and 106c), the individually addressable chambers shown in FIG. 2C (addressable chambers 206a, 206b, and 206c) have individually addressable ports (ports 201a, 201b, and 201c, respectively).

As shown by arrows 109, the graphene window/elastomeric substrate 205 is paired with a second substrate 107 (such as a chip). Second substrate 107 has target features (target features 108a, 108b, and 108c). During the pairing of the graphene window/elastomeric substrate 205 with the second substrate 107, the individually addressable chambers (addressable chambers 206a, 206b, and 206c) are aligned with the target features (target features 108a, 108b, and 108c, respectively) and then brought in contact with one another.

FIG. 2D depicts the graphene windows/elastomeric substrate 205 being brought into contact with the second substrate 107. (Similar to as shown in FIG. 1D, the graphene windows/elastomeric substrate 205 can be pressed onto the second substrate 107 to obtain this contact.) In this embodiment, the individually addressable chambers (addressable chambers 206a, 206b, and 206c) can be pressurized to the same pressure (i.e., P₁=P₂=P₃=Pₙ) or different pressures using the individually addressable ports (ports 201a, 201b, and 201c, respectively). This pressurization will pre-stretch the graphene of the graphene windows (graphene windows 101a, 101b, and 101c) before contact and assist in the transfer of the graphene windows to the second substrate 107 and remove wrinkles in the graphene windows prior to bonding.

FIG. 2E depicts the second substrate 107 after the graphene windows/elastomeric substrate 205 is removed, leaving behind the graphene windows (graphene windows 101a, 101b, and 101c) formerly in the array 100. Like the process illustrated in FIGS. 1A-1E, in such a process (illustrated in FIGS. 2A-2E), the graphene windows are transferred to the second substrate 107 such that they are aligned with the target features (target features 108a, 108b, and 108c, respectively).

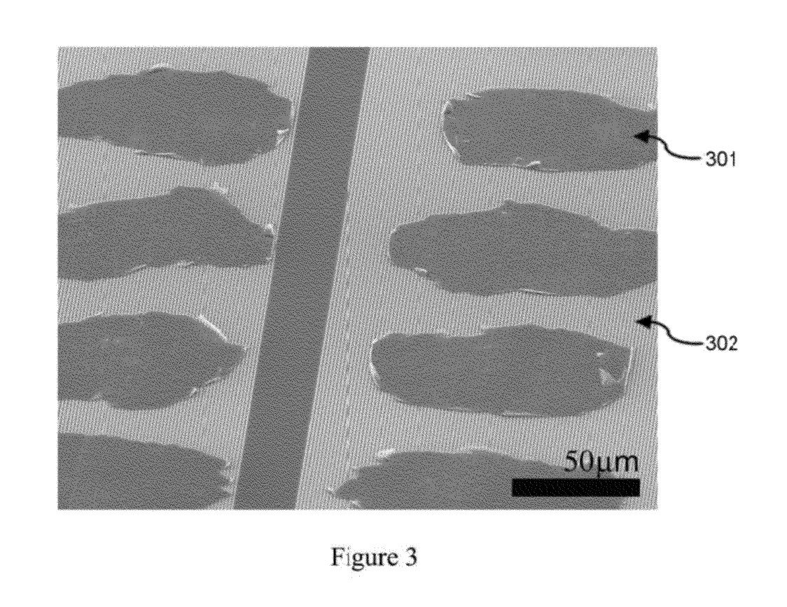

FIG. 3 is a SEM image of single-layer graphene windows 301 that have been transferred (utilizing the liquid-less transfer method described in FIGS. 1A-1E with polydimethylsiloxane as the elastomeric substrate) onto a patterned Si chip 302 with 200 nm-wide tungsten traces that were supported on a 200 nm-thick layer of thermal oxide.

This liquid-less transfer method is useful because the elastomeric substrate conforms to the metal foil/graphene window array and also to the underlying substrate/chip during transfer, thereby providing uniform contact. Additionally, with respect to the method depicted in FIGS. 2A-2E, the individually addressable ports in the elastomeric substrate allow one to pressurize specific individual graphene windows or groups of graphene windows before transfer to remove wrinkles and/or create pre-tension to improve the transfer efficiency. It has been found that the level of ambient humidity is a parameter that affects transfer efficiency (i.e., the percentage of thin membranes, such as graphene windows, transferred). Further, transfer of the thin membrane(s) does not require immersion in a liquid.

### Alignment of Transferred Thin Membranes

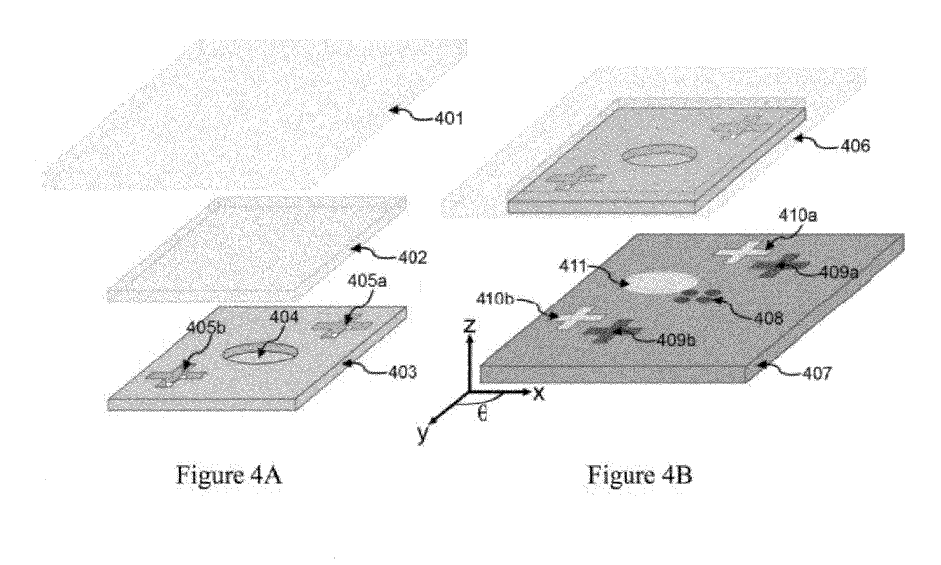

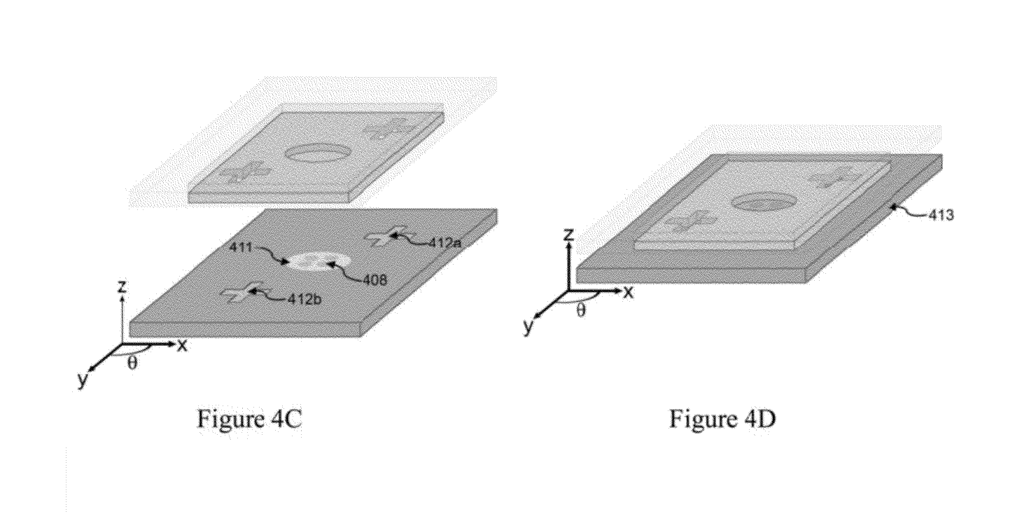

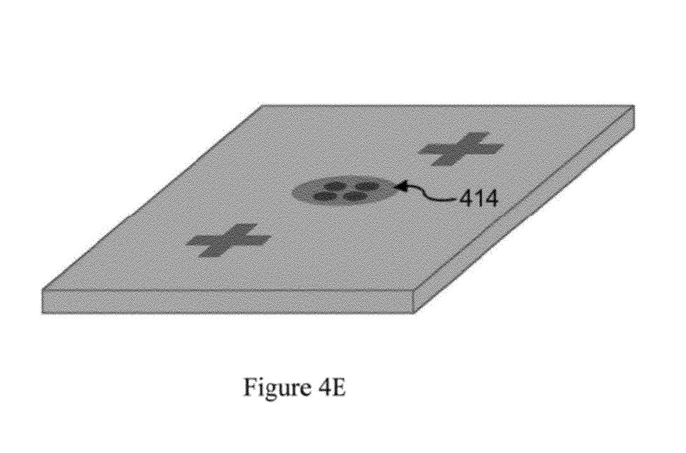

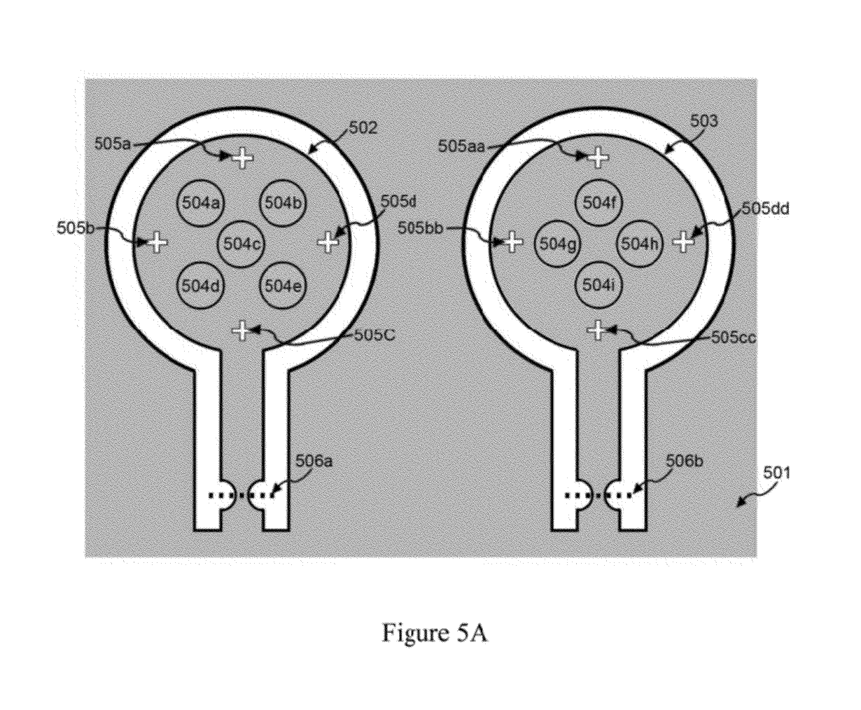

FIGS. 4A-4E illustrate an embodiment of the present invention in which a thin membrane window array is transferred to a substrate utilizing an alignment method.

FIG. 4A depicts an optically clear plate 401 (such as glass), an optically transparent elastomeric substrate 402 (such as PDMS), and metal foil 403 (such as Cu foil). The Cu foil has a thin membrane (graphene window 404) and alignment marks 405a and 405b. The optically clear plate 401, the optically elastomeric substrate 402, and the Cu foil 403 are brought together to form an assembly 406 (depicted in FIG. 4B) that is held together by weak, reversible secondary bonds.

In the orientation shown in FIG. 4B, using optical microscopy, a light source above the assembly 406 projects light that passes through the optically clear plate 401, the optically elastomeric substrate 402, through alignment marks 405a and 405b, and the graphene window 404 onto a substrate 407 (such as a chip) positioned below assembly 406. Substrate 407 has target feature 408 and alignment marks 409a and 409b. The light projected onto substrate 407 forms projections 410a and 410b (corresponding to alignment marks 405a and 405b, respectively) and projection 411 (corresponding to graphene window 404). Projections 410a, 410b, and 411 are used to align the graphene window 404 to target feature 408 on the substrate 407 using alignment marks 409a and 409b as index targets.

Using lateral translation (including rotation), alignment between assembly 406 and substrate 407 is achieved. As depicted in FIG. 4C, projections 410a and 410b are superimposed upon alignment marks 409a and 409b (shown as marks 412a and 412b, respectively). By such alignment, projection 411 is superimposed over target feature 408, such that when assembly 406 is brought in contact with substrate 407, graphene window 404 is aligned with feature 408 at the point of contact (as shown in the assembly/substrate 413 shown in FIG. 4D).

The assembly 406 can then be removed from the assembly/substrate 413 with the graphene window 404 remaining on substrate 407 and in contact with target feature 408 (as depicted in FIG. 4E aligned to thin membrane/target feature 414).

By this method, a thin membrane window array (such as a graphene window array) can be transferred onto the substrate with alignment/registry to the substrate. The thin membrane window array can be one thin membrane window or can be more than one thin membrane window. Thus, by this process, multiple thin membranes can be transferred while aligned to the substrate target features by simultaneously transferring an array of multiple thin membranes onto the substrate (such as by using Cu foil having multiple thin membrane windows).

Alignment marks patterned into the Cu foil and on the target chip allow translation of each surface relative to the other using standard translation stages (x, y, z, and θ) before bringing the thin membranes into direct contact with the underlying target features on the substrate/chip.

### Multiple Transfer Steps to Increase Transfer Density

Multiple thin membrane windows arrays can be transferred by a series of aligned transfers, which can be used to increase the density of the thin membranes transferred onto the substrate beyond what is capable through creation of a thin membrane window array on the supporting metal foil.

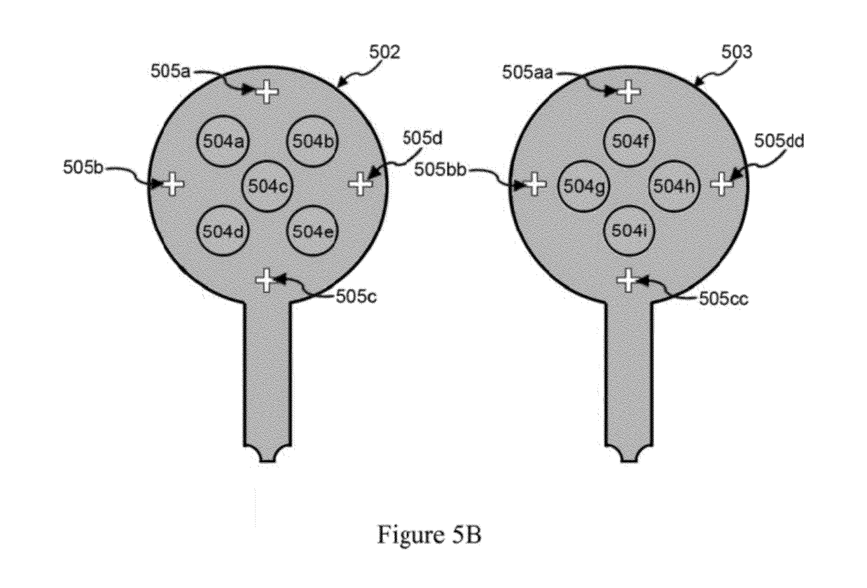

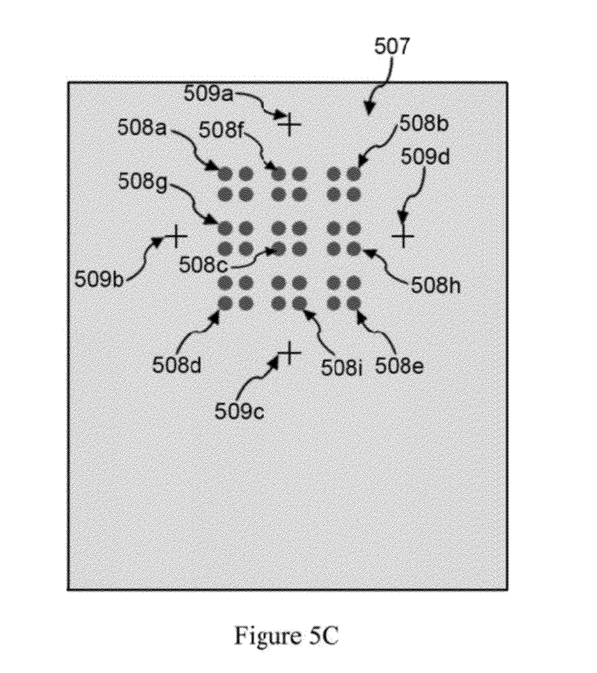

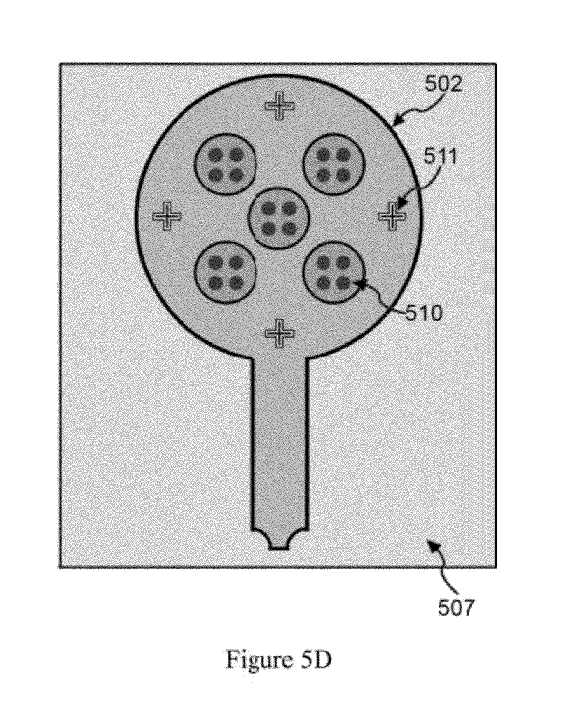

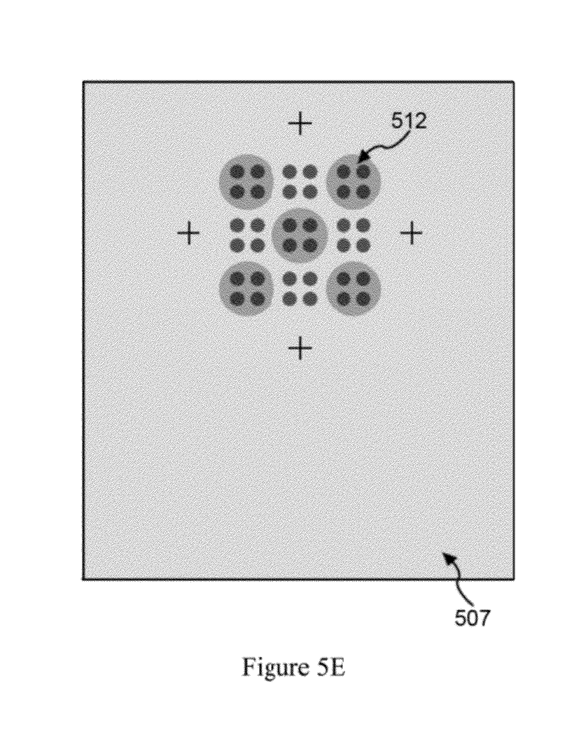

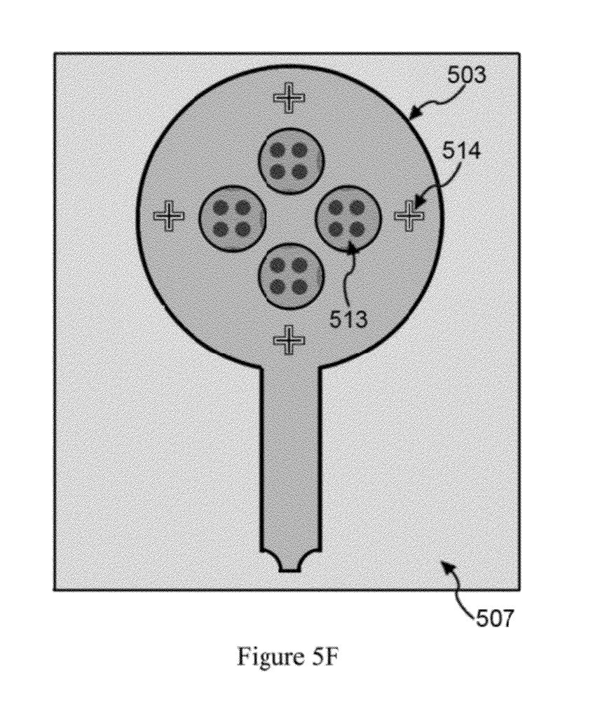

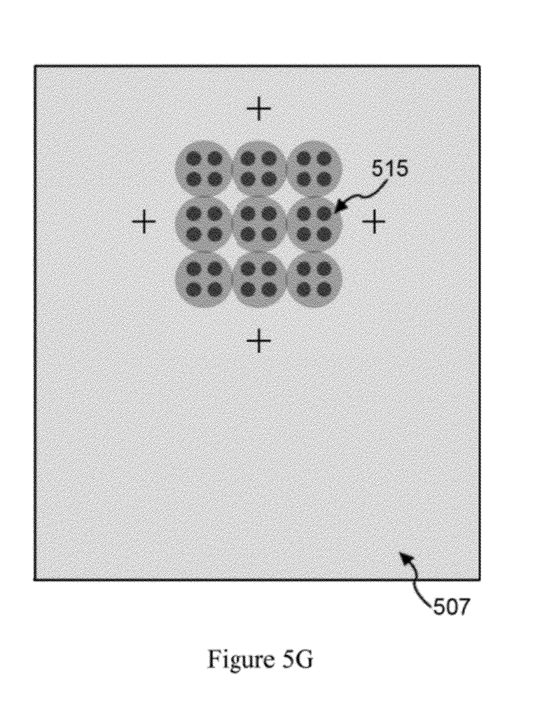

FIGS. 5A-5G illustrate an embodiment of the present invention in which multiple thin membrane window arrays are transferred to a substrate utilizing an alignment method to increase transfer density.

As depicted in FIG. 5A, a Cu foil 501 with an array of thin membranes (graphene windows 504a-504i) that have windows offset from each other (graphene windows 504a-504e in Cu foil area 502 and graphene windows 504f-504i in Cu foil area 503). Cu foil area 502 has alignment marks 505a-505d that are arranged identically to alignment marks 505aa-505dd in Cu foil area 503. Cu foil area 502 and Cu foil area 503 can be separated from rest of Cu foil 501 by cutting the foil at pre-designated locations 506a and 506b, respectively.

FIG. 5B depicts Cu foil area 502 and Cu foil area 503 after removal from the rest of Cu foil 501.

FIG. 5C depicts a substrate 507 (such as a chip) with target features 508a-508i and alignment marks 509a-509d.

FIG. 5D depicts Cu foil area 502 aligned with substrate 507 using the alignment marks 505a-505d (of Cu foil area 502) and alignment marks 509a-509d (of substrate 507), respectively, such as demonstrated above in FIGS. 4A-4D. By this process, graphene windows 504a-504e are properly aligned before being brought into contact with target features 508a-508e, respectively. For instance, as shown in FIG. 5D, graphene window 504e is in contact with target feature 508e at graphene window/target feature 510. Likewise, for instance, alignment mark 505d is overlaying alignment mark 509d at alignment mark/alignment mark 511.

Similar to as shown in FIG. 4E, graphene windows 504a-504e are then transferred to the substrate 507 such that Cu foil 502 is removed, leaving graphene windows 504a-504e on target features 508a-508e, respectively. FIG. 5E depicts substrate 507 after the removal of Cu foil 502 (with graphene windows 504a-504e transferred in alignment). For instance, graphene window 504b is in contact with target feature 508b at graphene window/target feature 512.

FIG. 5F depicts Cu foil area 503 aligned with substrate 507 using the alignment marks 505aa-505dd (of Cu foil area 503) and alignment marks 509a-509d (of substrate 507), respectively, such as demonstrated above in FIGS. 4A-4D. By this process, graphene windows 504f-504i are properly aligned to come in contact with target features 508f-508i, respectively. For instance, as shown in FIG. 5F, graphene window 504h is in contact with target feature 508h at graphene window/target feature 513. Likewise, for instance, alignment mark 505dd is overlaying alignment mark 509d at alignment mark/alignment mark 514.

Similar to as shown in FIG. 4E, graphene windows 504f-504i are then transferred to the substrate 507 such that Cu foil 502 is removed, leaving graphene windows 504f-504i on target features 508f-508i, respectively. FIG. 5G depicts substrate 507 after the removal of Cu foil 503 (with graphene windows 504f-504i transferred in alignment). For instance, graphene window 504h is in contact with target feature 508h at graphene window/target feature 515.

Additional alignment and transfer steps can be performed to further increase transfer density. Thus, by this approach, a higher density of graphene windows is attainable.

### Alignment of Transferred Thin Membrane Structures to Apposing Substrates

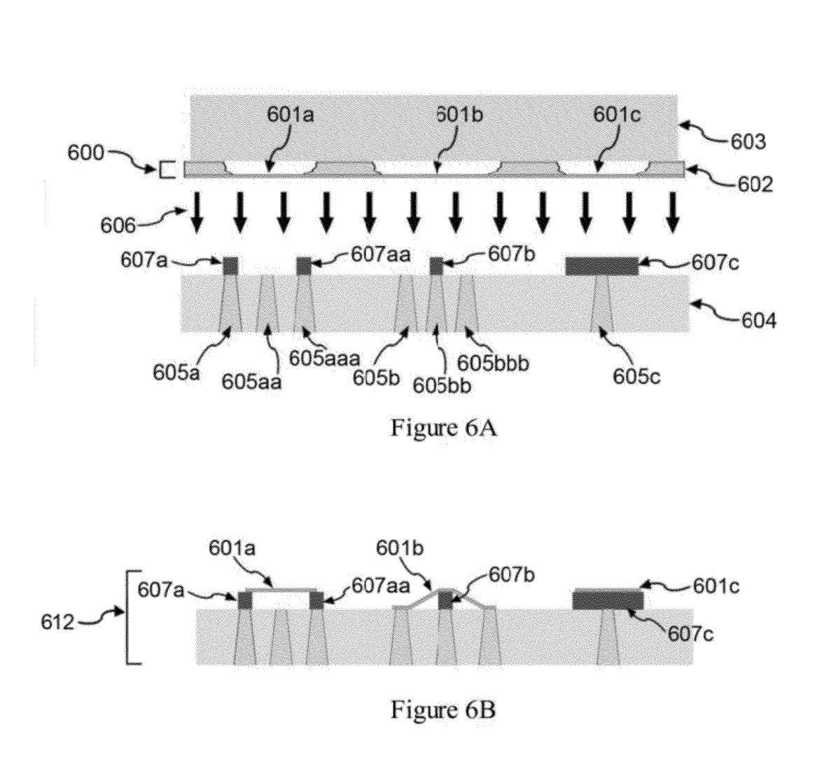

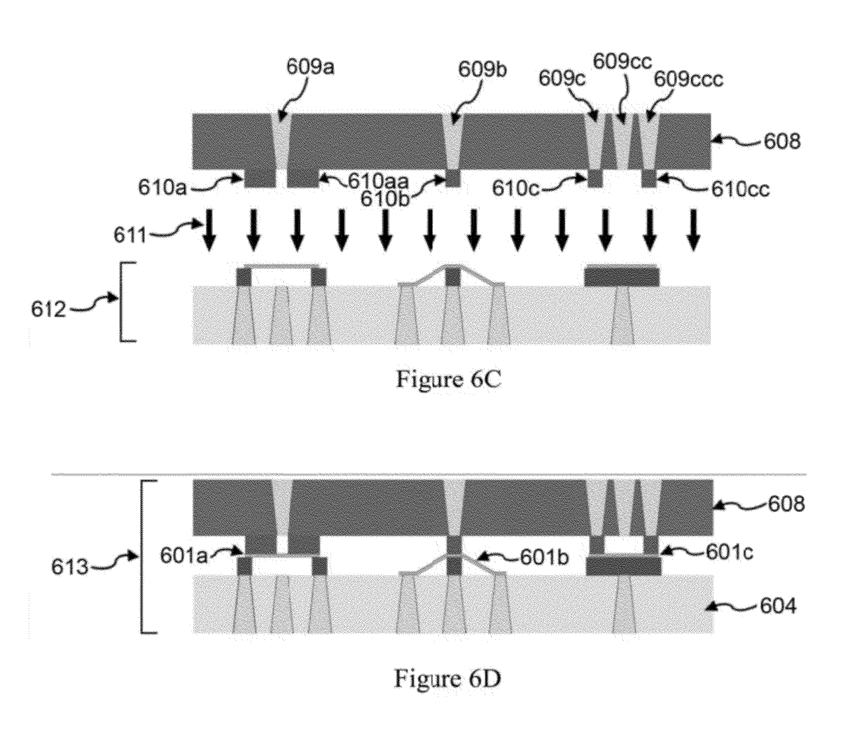

FIGS. 6A-6D illustrate an embodiment of the present invention in which a thin membrane window array is transferred to apposing substrate/chips utilizing an alignment method.

FIG. 6A depicts an array 600 of thin membranes (graphene windows 601a, 601b, and 601c) on Cu foil 602 adhered to an elastomeric substrate 603 (e.g., cross-linked PDMS) is aligned and brought into contact (as shown with arrows 606) with a target substrate/chip 604 with through-vias (through-vias (i) 605a, 605aa, and 605aaa, (ii) 605b, 605bb, and 605bbb, and (iii) 605c) connected to substrate target features (i) 607a and 607aa, (ii) 607b, and (iii) 607c, respectively.

Using the alignment and transfer methods discussed above, this results in transferred graphene windows (i) 601a, (ii) 601b, and (iii) 601c on the on substrate target features (i) 607a and 607aa, (b) 607b, and (c) 607c, respectively (assembly 612 in FIG. 6B).

As depicted in FIG. 6C, a second substrate 608 (such as a chip) with through-vias (i) 609a, (ii) 609b, and (iii) 609c, 609cc, and 609ccc connected to target features (i) 610a and 610aa, (b) 610b, and (c) 610c and 610cc respectively, is aligned and brought into contact (as shown by arrows 611) with the assembly 612 utilizing the alignment method discussed above.

FIG. 6D depicts the resulting assembly (device) 612. Assembly 612 comprises aligned thin membranes (graphene windows 601a, 601b, and 601c) sandwiched between the two aligned substrates (substrates 604 and 608).

A number of embodiments of the invention have been described. Nevertheless, it will be understood that various modifications may be made without departing from the spirit and scope of the invention. Accordingly, other embodiments are within the scope of the following claims.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, other embodiments are within the scope of the following claims. The scope of protection is not limited by the description set out above, but is only limited by the claims which follow, that scope including all equivalents of the subject matter of the claims.

The disclosures of all patents, patent applications, and publications cited herein are hereby incorporated herein by reference in their entirety, to the extent that they provide exemplary, procedural, or other details supplementary to those set forth herein.

What is claimed is:

1. A method of comprising the steps of:
(a) back etching a first thin membrane substrate to form a first thin membrane window array, wherein the first thin membrane substrate has a first side and a second side, and the first thin membrane window array is formed on the second side of the first thin membrane substrate;
(b) adhering a first side of a flexible substrate to the first side of the first thin membrane substrate;
(c) aligning the first thin membrane window array to a first side of a target substrate, wherein the first side of the target substrate comprises a first target feature array to which the first thin membrane window array is aligned;
(d) contacting the first thin membrane window array to the first side of the target substrate while maintaining alignment; and
(e) transferring the first thin membrane window array to the first target feature array on the first side of the target substrate.

2. The method of claim 1 further comprising adhering a first side of a rigid substrate to a second side of the flexible substrate.

3. The method of claim 2, wherein the rigid substrate is transparent.

4. The method of claim 2, wherein the rigid substrate comprises glass.

5. The method of claim 1, wherein the flexible substrate is transparent.

6. The method of claim 1, wherein the flexible substrate is an elastomer.

7. The method of claim 6, wherein the elastomer comprises cross-linked polydimethylsiloxane.

8. The method of claim 1 further comprising removing the flexible substrate and the first thin membrane substrate while maintaining the first thin membrane window array on the first target feature array of the target substrate.

9. The method of claim 1, wherein the first thin membrane substrate is a metal.

10. The method of claim 1, wherein the mean surface roughness is less than 0.5 microns.

11. The method of claim 9, wherein the metal is copper.

12. The method of claim 1, wherein the first thin membrane window array comprises graphene.

13. The method of claim 1, wherein the first thin membrane window array comprises graphene oxide.

14. The method of claim 1, wherein the first thin membrane window array comprises a graphene/thin metal film composite.

15. The method of claim 1, wherein the first thin membrane window array has no more than one thin membrane window.

16. The method of claim 1, wherein the first thin membrane window array comprises more than one thin membrane windows.

17. The method of claim 1, wherein
(a) the first thin membrane substrate comprises a first set of alignment marks,
(b) the target substrate comprises a second set of alignment marks, and
(c) the step of aligning the first thin membrane window array to a first side of a target substrate comprises aligning the first set of alignment marks with the second set of alignment marks.

18. The method of claim 1, further comprising transferring a second thin membrane window array to the first side of the target substrate.

19. The method of claim 18, wherein the step of transferring the second thin membrane window array to the first side of the target substrate comprises:
(a) aligning the second thin membrane window array to the first side of a target substrate, wherein
(i) the second thin membrane window array is located on a second side of the second thin membrane window substrate, and
(ii) the first side of the target substrate comprises a second target feature array to which the second thin membrane window array is aligned;
(b) contacting the second side of the second thin membrane window array against the first side of the target substrate while maintaining alignment; and
(c) transferring the thin membranes of the second thin membrane window array to the second target feature array on the first side of the target substrate.

20. The method of claim 18, wherein the second thin membrane window array is aligned with the first thin membrane window array.

21. The method of claim 20 wherein the second thin membrane window array is aligned with the first thin membrane window array to create an array of transferred two-layer membrane features.

22. The method of claim 18, wherein the second thin membrane window array is offset from the first thin membrane window array.

23. The method of claim 1 further comprising utilizing a gas pressure differential to assist in the transfer of the thin membranes to the first target feature array.

24. The method of claim 1 further comprising utilizing a vapor contained within a gas during transfer.

25. The method of claim 24, wherein the gas is air.

26. The method of claim 24, wherein the ratio of partial pressure of the vapor to the saturation pressure is in excess of 0.2.

27. The method of claim 26, wherein the vapor comprises water in an amount that is at least about 20% relative humidity.

28. The method of claim 27, wherein the gas is air.

29. The method of claim 1, further comprising
(a) aligning a first side of the second target substrate to the first thin membrane window array on the first side of the target substrate, wherein the first side of the second target substrate has a second target feature array on the first side of the second target substrate;
(b) contacting the first thin membrane window array to the first side of the second target substrate while maintaining alignment such that the first thin membrane window array is sandwiched between the target substrate and the second target substrate.

30. The method of claim 29, wherein the first target substrate comprises an array of electromechanical switches.

31. The method of claim 29, wherein the first target substrate comprises an array of electromechanical sensors.

32. The method of claim 29, wherein the second target substrate comprises an array of electromechanical switches.

33. The method of claim 29, wherein the second target substrate comprises an array of electromechanical sensors.

34. The method of claim 1, wherein the graphene windows transferred to the target substrate are used in a graphene pump.

35. The method of claim 1, wherein the graphene windows transferred to the target substrate are used in a NEMS device.
